(19) United States
(12) Patent Application Publication
(10) Pub. No.: US 2002/0074835 A1
(43) Pub. Date: Jun. 20, 2002

(54) Device convertible to a highchair, child carrier holder, booster chair, rocking chair, and step stool

(76) Inventor: Beth Chalender, Savannah, MO (US)

Correspondence Address: J. David Wharton, SHOOK, HARDY & BACON L.L.P., 1200 Main Street, Kansas City, MO, 64105-2118, US

(21) Appl. No.: 09/742,138

(22) Filed: Dec. 20, 2000

(51) Int. Cl. B60N 2/32; A47C 13/00

(52) U.S. Cl. 297/118

(57) ABSTRACT

A device convertible to present a child's highchair, booster chair, child carrier holder, rocking chair, and/or step stool or child's table has, generally, a chair with a back support, seat, and arms, a chair support assembly coupled to the seat, a tray assembly removably coupled to the chair arms, and a rocking assembly. The tray assembly is removably coupled, in a generally horizontal plane, to and above the chair arms to present a conventional highchair. The tray assembly is removably coupled, in a generally vertical plane, to the chair arms to present a child carrier holder. The tray assembly is removed entirely from the device to present a booster chair. The device may also have a chair support assembly having upper and lower leg assemblies removably coupled to each other, and a tray assembly having an inner tray removably coupled to an outer tray frame. In this way, the device is further convertible to a child's rocking chair by uncoupling the lower leg assemblies from the upper leg assemblies and removably coupling the rocking assembly to the upper leg assemblies, and to a step stool or child's table by removably coupling the lower leg assemblies to the inner tray.

### BACKGROUND OF THE INVENTION

Highchairs for infants and young children are commonly used in the home, in restaurants, and elsewhere. Parents and other care givers often place infants and young children in highchairs during meals and at other times to adequately support and safely restrain the child. Parents and care givers also commonly use child carriers to safely and easily transport an infant or young child. However, adults wishing to transfer a child from a carrier to a highchair, for feeding or other purposes, have been required to either remove the child from the carrier and place the child on the adult's lap, remove the child from the carrier and place the child in a highchair, or leave the child in the carrier and place the child and carrier on a tabletop or the seat of a conventional chair.

For example, in a restaurant, if a highchair is not available or an adult chooses not to place a child in a highchair, the child and child carrier are often placed on a tabletop or on the seat of a conventional chair. Tabletops and conventional chairs, however, are not designed to safely support and adequately restrain a child carrier. As a result, a child carrier place on a tabletop or conventional chair may slide from the tabletop or chair, or can easily be bumped and dislodged from the tabletop or chair. The child and carrier then fall to the ground, almost invariably resulting in serious injury to the child. Also, holding a child in an adult's lap is a considerably less convenient and safe method of supporting and positioning a child than placing the child in a highchair. Furthermore, if a highchair is available and desired, the adult must still transfer the child, who may be sleeping, from the child carrier to the highchair. Accordingly, there is a need for a single device that may be used as a conventional highchair but that may be quickly and easily converted to accommodate and safely support a child carrier holder.

The same device described above for use in restaurants and other locations outside the home could also be used inside the home, and would include additional features to make the device even more flexible and attractive to both adults and children. For example, adults may find it convenient to convert the device into a step stool to access cupboards and items that are stored out of one's ordinary reach. This same step stool could be used by the child as a table for drawing and other activities. In addition, adults might convert the device into a child's rocking chair. A single device, for use inside or outside the home, and which is readily convertible to present a conventional highchair, child carrier holder, booster chair, rocking chair, and/or step stool/child's table, has not previously been available to parents, children, restaurant owners, and others.

### SUMMARY OF THE INVENTION

Accordingly, it is an object of the present invention to provide a device quickly and easily convertible from a highchair to a child carrier holder, and vice versa.

It is a further object of the present invention to provide a device quickly and easily convertible to a child carrier holder that will safely support and adequately restrain a child carrier.

It is a further object of the present invention to provide a device quickly and easily convertible from a highchair to a booster chair, and vice versa.

Another object of the present invention is to provide a device quickly and easily convertible from a highchair to a step stool or child's table, and vice versa.

An additional object of the present invention is to provide a device quickly and easily convertible from a booster chair to a child's rocking chair, and vice versa.

Accordingly, the present invention provides for a single device convertible to present a child's highchair, a child carrier holder, a booster chair, a rocking chair, and/or a step stool. The device has, generally, a chair including a back support, a seat, and a pair of arms, a chair support assembly coupled with the seat, a tray assembly removably coupled to the chair arms, and a rocking assembly adapted to be removably coupled with the device. The tray assembly is removably coupled, in a generally horizontal plane, to and above the chair arms to present a conventional highchair. The tray assembly is removably coupled, in a generally vertical plane, to the arms to present a child carrier holder. The tray assembly may be removed entirely from the device to present a booster chair.

The device is further convertible by constructing the device with a chair support assembly having separate upper and lower leg assemblies removably coupled to each other, and a tray assembly having an inner tray removably coupled to an outer tray frame. With the lower leg assemblies and tray assembly removed from the device, the rocking assembly may be attached to the upper leg assemblies of the device to present a child's rocking chair. Finally, with the lower leg assemblies removed from the device and the inner tray removed from the outer tray frame, the inner tray may be attached to the lower leg assemblies to present a step stool or child's table.

Additional objects, advantages, and novel features of the invention will be set forth in part in a description which follows, and in part will become apparent to those skilled in the art upon examination of the following, or may be learned by practice of the invention.

### BRIEF DESCRIPTION OF THE DRAWINGS

In the accompanying drawings which form a part of this specification and are to be read in conjunction therewith, and in which like reference numerals are used to indicate like parts in the various views:

FIG. 1 shows the device according to the present invention in its child carrier holder configuration, in perspective view.

FIG. 2 is a perspective view showing the device according to the present invention in its highchair configuration.

FIG. 3 is a perspective view showing the device according to the present invention in its booster chair configuration.

FIG. 4 is a perspective view showing the device according to the present invention in its rocking chair configuration.

FIG. 5 is a perspective view showing the device according to the present invention in its step stool configuration, with the inner tray removably coupled with the lower leg assemblies.

FIG. 6 is an enlarged fragmentary elevation view taken along line 6-6 of FIG. 2 showing the tray assembly removably coupled with the chair arm in the device's highchair configuration.

FIG. 7 is an enlarged fragmentary elevation view taken along line 7-7 of FIG. 1 showing the tray assembly removably coupled with the chair arm in the device's child carrier holder configuration.

FIG. 8 is a cross-sectional view taken along line 8-8 of FIG. 6 showing the tray assembly removably coupled with the chair arm in the device's highchair configuration.

FIG. 9 is a cross-sectional view taken along line 9-9 of FIG. 6 showing the inner tray removably coupled with the tray frame.

FIG. 10 is detailed fragmentary elevation view with portions broken away showing the upper legs removably coupled with the lower legs.

### DETAILED DESCRIPTION OF THE PREFERRED EMBODIMENTS

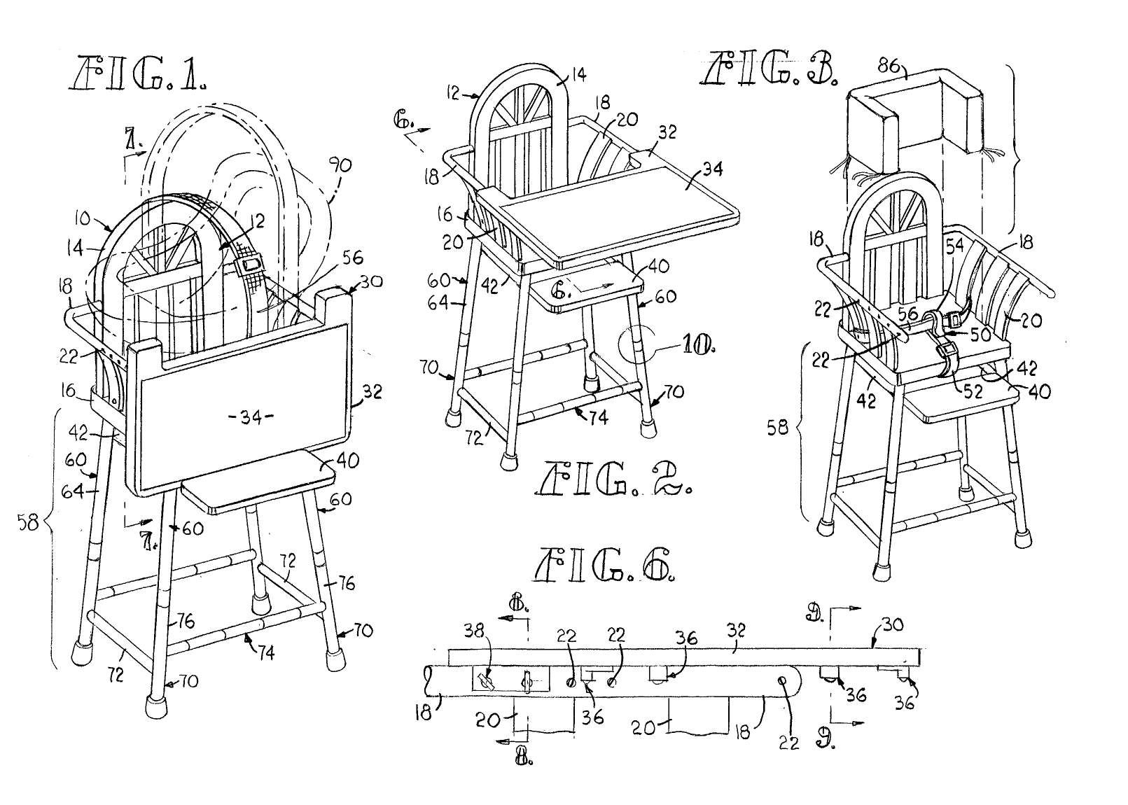

Referring to the drawings in greater detail, and initially to FIGS. 1-3, a device designated generally by the numeral 10 is shown. Device 10 generally includes a chair 12 in which a child may be seated. Chair 12 has a back support 14 attached to a seat 16. A pair of arms 18 are attached to back support 14 and to seat 16 via arm support members 20. Chair 12 is supported by a chair support assembly 58. A tray assembly 30 may be removably coupled to arms 18 to present a highchair as shown in FIG. 2 or a child carrier holder as shown in FIG. 1. Device 10 may further include a footrest 40 removably coupled to chair support assembly 58. As shown in FIG. 7, footrest 40 is attached to footrest rails 44 which, in turn, are slidably coupled to footrest rungs 42. The position of footrest 40 may accordingly be moved toward or away from chair support assembly 58.

In the highchair configuration of device 10 shown in FIG. 2, tray assembly 30 is removably coupled in a substantially horizontal plane with arms 18. Tray assembly 30 is removably coupled to arms 18 as depicted in FIGS. 6 and 8. A plurality of holes 22 are formed within arms 18 to receive spring-loaded pin assembly 38. Holes 22 are generally positioned along the length of arms 18 from back support 14 to the ends of arms 18. As best shown in FIG. 6, in the highchair configuration of device 10, tray assembly 30 is positioned above arms 18, and spring-loaded pin assembly 38 is received by hole 22 to couple tray assembly 30 to arms 18. The position of tray assembly 30 may be moved in a horizontal plane closer to or further from back support 14, depending upon which hole 22 receives pin assembly 38. As best shown in FIG. 8, tray assembly 30 is uncoupled from arms 18 by manually applying a force on spring-loaded pin assembly 38 away from arm 18 and hole 22 to disengage pin assembly 38 from hole 22. It will be appreciated that one or more spring-loaded pin assemblies 38 may be used to removably couple tray assembly 30 to arms 18, and that other mechanical means well-known to those skilled in the art may be adopted to removably couple tray assembly 30 to arms 18.

In the child carrier holder configuration of device 10 shown in FIG. 1, tray assembly 30 is removably coupled in a substantially vertical plane with arms 18. As shown in FIG. 7, tray assembly 30 is removably coupled to arms 18. A hole 22 positioned at or near the end of arm 18 receives spring-loaded pin assembly 38 to support and removably couple tray assembly 30 to arm 18. Tray assembly 30 may further be supported and restrained at its lower edge by footrest 40 to maintain tray assembly 30 in a substantially vertical position.

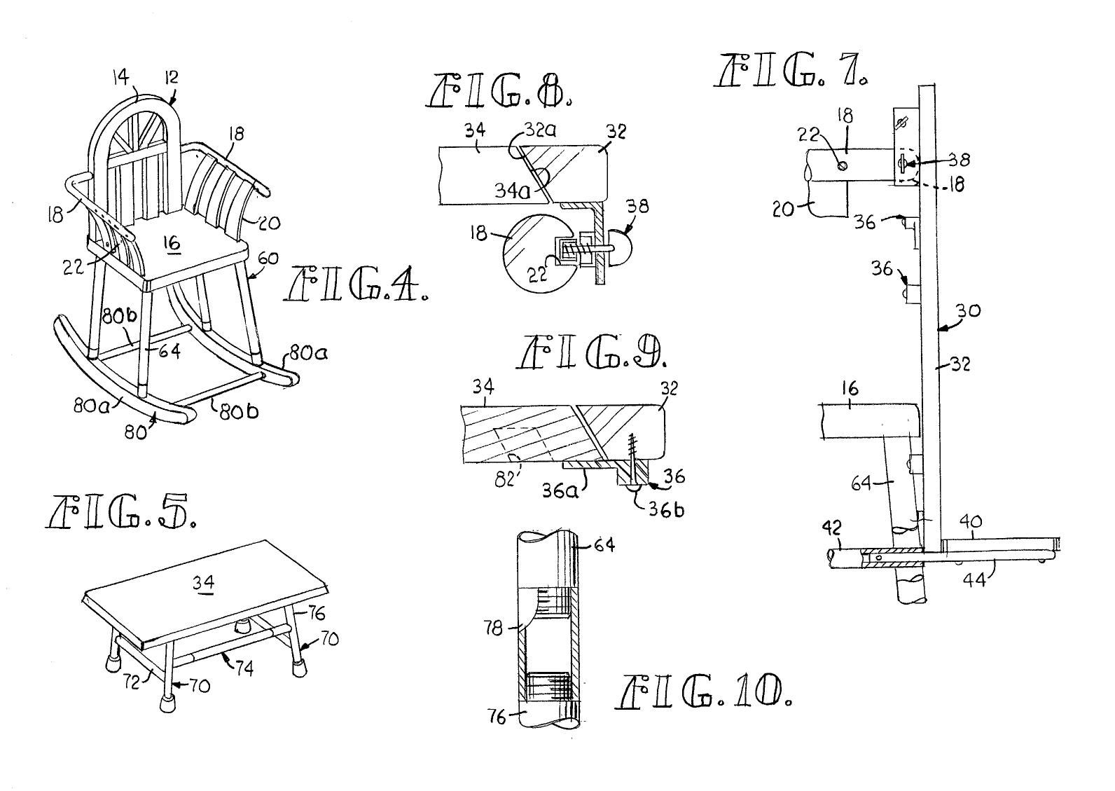

As shown in FIGS. 1 and 2, tray assembly 30 includes an inner tray 34 removably coupled to an outer tray frame 32 by tray clip assembly 36. Clip assembly 36 includes tab 36a and fastener 36b. Tab 36a may be manually rotated about fastener 36b to position tab 36a beneath tray 34 to support tray 34 and removably coupled tray 34 to frame 32. A plurality of tray clip assemblies 36 are generally used to adequately support tray 34 and couple inner tray 34 to frame 32. In addition, as shown in FIGS. 8 and 9, edge 34a of inner tray 34 and edge 32a of frame 32 are beveled. Complementary beveled edges 34a and 32a, in conjunction with tray clip assemblies 36, ensure that inner tray 34 does not separate and become uncoupled from frame 32 when tray assembly 30 is placed in a substantially vertical position, as when device 10 is configured to present a child carrier holder as shown in FIG. 1. Alternatively, tray assembly 30 may consist of a single continuous piece without a removable inner tray 34. Device 10 could then be converted to present a highchair, a child carrier holder, or a booster chair only. This configuration would likely be preferred by restaurant owners and others who do not wish to use device 10 in its rocking chair or step stool configurations shown in FIG. 4 and FIG. 5 respectively.

To enable device 10 to be converted into its rocking chair configuration depicted in FIG. 4 and/or its step stool configuration depicted in FIG. 5, chair support assembly 58 includes upper leg assemblies 60 fixedly coupled to seat 16, and lower leg assemblies 70 removably coupled to upper leg assemblies 60, as shown in FIGS. 1-3. Upper leg assembly 60 includes upper legs 64 fixed to the bottom of seat 16. Lower leg assembly 70 includes lower legs 70 removably coupled to upper legs 64, lower leg fixed rung 72 and adjustable rung assembly 74. Adjustable rung assembly 74 includes a plurality of interchangeable rung members. This enables one or more rung member(s) to be removed, as necessary, to adapt lower leg assembly 70 for attachment to inner tray 34, as depicted in FIG. 5 and discussed below. As shown in FIG. 10, upper leg 64 is removably coupled with lower leg 76 by mechanical means such as a sleeve 78. It is understood that other suitable mechanical connections well-know to one skilled in the art may be adopted to securely and removably couple upper leg 64 with lower leg 76. Alternately, chair support assembly 58 may be constructed without separate removable lower leg assemblies 70. Constructed in this manner, couplings such as sleeve 78 would not be required, and device 10 could not be configured to present a rocking chair or a step stool as depicted in FIGS. 4 and 5 respectively. This configuration may be preferred by restaurant owners and others who wish to use device 10 only in its highchair, child carrier holder, or booster chair configurations.

As shown in FIG. 4, when lower leg assemblies 70 are removed from upper leg assemblies 60, rocking assembly 80 may be removably attached to upper leg assemblies 60 to present a rocking chair. Rocking assembly 80 has curved runners 80a and braces 80b. Braces 80b are positioned between runners 80a, and the ends of braces 80b are coupled with runners 80a to form rocking assembly 80. Upper leg assemblies 60 may be removably attached to rocking assembly 80 by inserting the ends of upper legs 64 into apertures formed within runners 80a. It is understood that upper legs 64 may be removably attached to runners 80a by other mechanical means well-known to those skilled in the art, including sleeves, threaded couplings, and the like. Rocking assembly 80 is stored when not in use with device 10.

As best shown in FIG. 3, a restraint assembly 50 may be provided to restrain a child or a child carrier, depending upon the configuration of device 10 and restraint assembly 50. Restraint assembly 50 includes a first strap 52 and a second strap 56. First strap 52 is attached at one end to seat 16 and has a loop 54 at its other end. Second strap 56 has connectors at each end to permit the ends of second strap 56 to be removably attached to chair 12 at seat 16, back support 14, or arm support members 20. As shown in FIG. 3, second strap 56 is passed through loop 54 and attached at its ends to chair 12 to present a three-point child restraint harness. This harness may be used with device 10 in its configurations shown in FIGS. 2, 3, and 4. The harness is generally removed when device 10 is used in its child carrier holder configuration depicted in FIG. 1. In child carrier holder configuration depicted in FIG. 1, second strap 56 may be passed over a child carrier 90 placed within chair 12 and the ends of second strap 56 removably attached to chair 12 at seat 16 or back support 14 to restrain the child carrier 90 and hold carrier 90 in place.

Also as shown in FIG. 3, a support pad 86 may be used to provide support for a child seated within the chair 12. Pad 86 is generally U-shaped and may be removably attached with ties or other means to chair 12 at arm support members 20 and/or back support 14 to secure pad 86 to chair 12. Pad 86 may be constructed of varying thickness to provide adequate support for infants and children of various sizes and to ensure the child remains in an upright position and is able to reach tray assembly 30 when device 10 is in its highchair configuration depicted in FIG. 2.

In operation, a person may convert device 10 from a conventional highchair, as shown in FIG. 2, into a child carrier holder, as shown in FIG. 1, by first uncoupling tray assembly 30 from arms 18 by manipulating and disengaging spring-loaded pin assembly 38 from pin detent 22. Tray assembly 30 is then moved from a substantially horizontal plane to a substantially vertical plane and removably coupled to arms 18 by manipulating and engaging pin assembly 38 with pin detents 22 located at or near the end of arms 18, as shown in FIG. 7. The lower edge of tray assembly may be positioned to abut footrest 40 and/or footrest rails 44, as shown in FIG. 7, to restrain the lower edge and ensure tray assembly 30 remains in a substantially vertical position. As shown in FIG. 1, a child carrier 90 may then be placed above or on seat 16 and within the space formed by arms 18, back support 14, and tray assembly 30. The carrier 90 is thus restrained from beneath the carrier and on all four sides of the carrier to safely hold the carrier. The child carrier 90 may be further restrained by extending second strap 56 over child carrier 90 and removably attaching the ends of second strap 56 to seat 16 and/or back support 14.

Device 10 is converted from a conventional highchair or child carrier holder, as shown in FIGS. 2 and 1 respectively, to a booster chair, as shown in FIG. 3, by uncoupling tray assembly 30 from arms 18 and removing tray assembly 30 from device 10.

Device 10 may further be converted from a booster chair, as shown in FIG. 3, to a rocking chair and/or step stool, as shown in FIGS. 4 and 5 respectively. For this conversion, inner tray 34 is first removed from tray frame 32 by pivoting tabs 36a of tray clip assemblies 36 away from inner tray 34 such that inner tray 34 may be detached from frame 32. Frame 32 may then be set aside. To present a step stool, lower leg assemblies 70 are uncoupled from upper leg assemblies 60 and then removably coupled to inner tray 34 by inserting the ends of lower legs 76 into leg apertures 82. The length of lower leg adjustable rung assemblies 74 may be adjusted by adding or removing rung members to enable lower legs 76 to align with leg apertures 82. The step stool depicted in FIG. may also be used as a child's table. After lower leg assemblies 70 have been uncoupled from upper leg assemblies 60, rocking assembly 80 may then be removably coupled to the upper leg assemblies 60 of device 10 to present a child's rocking chair as depicted in FIG. 4.

Removable footrest 40 may be used with device 10 in its highchair and booster chair configurations to increase the safety and comfort of the child, but is typically not used with device in its rocking chair configuration.

It will be seen from the foregoing that this invention is one well adapted to attain the ends and objects set forth above, and to attain other advantages which are obvious and inherent in the device. It will be understood that certain features and subcombinations are of utility and may be employed without reference to other features and subcombinations. This is contemplated by and within the scope of the claims. It will be appreciated by persons skilled in the art that the present invention is not limited to what has been particularly shown and described hereinabove. Rather, all matter herein set forth or shown in the accompanying drawings is to be interpreted as illustrative and not limiting.

I claim:

1. A device convertible to present a highchair, a child carrier holder, and a booster chair comprising:
a chair comprising a seat, a back support, and a pair of arms;
a chair support assembly coupled with said seat;
a tray assembly removably coupled with said arms;
whereby when said tray assembly is coupled in a horizontal plane with said arms said device presents a high chair, and when said tray assembly is coupled in a vertical plane with said arms said device presents a child carrier holder, and when said tray assembly is removed from said arms said device presents a booster chair.

2. The device of claim 1, further comprising a footrest removably coupled with said chair support assembly.

3. The device of claim 1, further comprising a restraint assembly, said restraint assembly comprising a first strap and a second strap, said first and second straps having first and second ends, said first end of said first strap attached to said seat, said second end of said first strap having a loop, whereby said second strap is extended through said loop and said ends of said second strap are removably attached to said chair to present a child restraint harness.

4. The device of claim 3, whereby when said tray assembly is in said vertical plane, said second strap is adapted to be extended over a child carrier positioned within said chair and said ends of said second strap are removably attached to said chair to restrain said carrier.

5. The device of claim 1, further comprising a generally U-shaped pad adapted to be placed on said seat adjacent said arms and said back support and removably attached to said chair, said pad providing support for a child seated within said chair.

6. A device convertible to present a highchair, a child carrier holder, a booster chair, and a rocking chair comprising:
a chair comprising a seat, a back support, and a pair of arms;
a chair support assembly coupled with said seat, said chair support assembly comprising first and second upper leg assemblies and first and second lower leg assemblies, said upper leg assemblies fixedly coupled with said seat and removably coupled with said lower leg assemblies;
a tray assembly removably coupled with said arms;
a rocking assembly comprising curved runners and braces, said braces positioned between and coupled with said curved runners, said rocking assembly adapted to be removably coupled with said upper leg assemblies when said lower leg assemblies have been removed from said upper assemblies;
whereby when said tray assembly is coupled in a horizontal plane with said arms said device presents a high chair, and when said tray assembly is coupled in a vertical plane with said arms said device presents a child carrier holder, and when said tray assembly is removed from said arms said device presents a booster chair, and when said rocking assembly is coupled with said upper leg assemblies said device presents a rocking chair.

7. The device of claim 6, said tray assembly comprising a frame and an inner tray removably coupled with said frame, said inner tray adapted to be removably coupled with said lower leg assemblies when said inner tray has been removed from said frame and said lower leg assemblies have been removed from said upper leg assemblies to thereby present a step stool.

8. The device of claim 6 or 7, further comprising a footrest removably coupled with said upper leg assemblies.

9. The device of claim 6 or 7, further comprising a restraint assembly, said restraint assembly comprising a first strap and a second strap, said first and second straps having first and second ends, said first end of said first strap attached to said seat, said second end of said first strap having a loop, whereby said second strap is extended through said loop and said ends of said second strap are removably attached to said chair to present a child restraint harness.

10. The device of claim 9, whereby when said tray assembly is in said vertical plane, said second strap is adapted to be extended over a child carrier positioned within said chair and said ends of said second strap are removably attached to said chair to restrain said carrier.

11. The device of claim 6 or 7, further comprising a generally U-shaped pad adapted to be placed on said seat adjacent said arms and said back support and removably attached to said chair, said pad providing support for a child seated within said chair.
